(19) United States
(12) Patent Application Publication
(10) Pub. No.: US 2024/0117508 A1
(43) Pub. Date: Apr. 11, 2024

(54) METHOD FOR SEALING AN ELECTROLYSIS CELL

(71) Applicant: WEW GmbH, Dortmund (DE)

(72) Inventor: Wiebke LÜKE, Dortmund (DE)

(21) Appl. No.: 18/277,001

(22) PCT Filed: Feb. 19, 2022
(86) PCT No.: PCT/EP2022/051128

§ 371 Date: Aug. 11, 2023

(30) Foreign Application Priority Data
Feb. 11, 2021 (DE) 10 2021 103185.0

(51) Int. Cl. C25B 9/60; C25B 9/19; C25B 9/63; C25B 15/08

(52) U.S. Cl. CPC C25B 9/60; C25B 9/19; C25B 9/63; C25B 15/08

(57) ABSTRACT

A method for the sealing and electrical insulation of electrolysis cells is proposed, wherein an electrically insulating plastic is introduced into the sealing surface between the two half-cells of the device.

### FIELD OF THE INVENTION

The invention concerns the field of electrolysis technology and relates to a method for the sealing and electrical insulation of electrolysis cells, to corresponding electrolysis cells and to the use of particular plastics for the sealing.

### BACKGROUND

An economy without greenhouse gases within the next 30 years—this is the stated aim of Europe in order to stop climate change. Renewable energies are intended to replace fossil fuels such as oil, coal and gas. In the course of the sustainable reconfiguration of the energy supply, hydrogen will play an important role.

For clean mobility, the efficient supply of electricity and heat, as a buffer to compensate for fluctuating renewable energies, as a basis for alternative fuels or as a process gas in industry—hydrogen is very versatile as energy carrier, can be used across sector boundaries, offers great synergy potentials and contains three times as great an energy density as gasoline in terms of mass.

Sustainably and economically generated hydrogen is therefore a cornerstone for greatly reducing the emission especially of the harmful greenhouse gas CO₂ in the fields of energy, transportation and industry, and thereby combating climate change. The construction of a cross-sector hydrogen economy that is as global as possible at the same time opens up enormous opportunities for new technologies and business models, since the possibilities of using hydrogen are very widespread. For industry, hydrogen-powered gas turbines are currently being researched. In fuel cells, it can be used for automobiles or buses. With hydrogen, it is possible not only to drive emission-free, but also, in contrast to electrically powered vehicles, to cover long distances and to refuel vehicles quickly.

From environmental viewpoints, the production of hydrogen by electrolysis of water is of particular interest; the term “green hydrogen” is therefore also used in this context. The method is carried out in coupled electrolysis cells, so-called electrolyzers, such as are also known from chloralkali electrolysis.

### RELEVANT PRIOR ART

U.S. Pat. No. 5,599,430 B (DOW) has already disclosed an electrolysis cell, which comprises a housing that contains at least one pair of electrodes, namely a cathode and an anode, a current collector and a membrane. It furthermore contains an electrically conductive, hydraulically permeable resilient mattress, which is arranged substantially coplanar with the current collector, and touches it on one side, and likewise extends coplanar with an electrode and touches it on the other side.

EP 1451389 B1 (UHDENORA) describes a current collector for electrochemical cells, consisting of a “sandwich” of compressible and resilient layers of metal wires, which imparts a predetermined mechanical load under a broad compression range.

EP 1766104 B1 (UHDENORA) relates to a conventional electrolysis cell having a sealing system consisting of individual elements, each of which contains two electrodes that are separated from one another by membranes, wherein the portion of inactive membrane surface is minimized by a flange so that the ratio between the flange surface of a semi-shell and the active membrane surface can be set to less than 0.045.

According to EP 1882758 A1 (TOAGOSEI), the resilient pressure in an electrolysis cell is transmitted with the aid of coils or wavy mats or resistive nickel alloys; the number of turns in the coils, or the number of layers placed above one another in the mats, increases stepwise from the top downward, so that a pressure profile that is at least similar to the hydrostatic pressure increasing in the same direction on the anode side is ultimately set up.

EP 2356266 B1 (UHDENORA) describes an electrolysis cell, which is provided with a separator and has a planar flexible cathode that is kept in contact with the separator by an elastic conductive element pressed by a current distributor. The cell furthermore contains an anode, which consists of a punched sheet or mesh supporting the separator. The cell may be used in a modular arrangement to form an electrolyzer whose terminal cells are only connected to the electrical power supply. The electrical continuity between adjacent cells is assured by conductive contact strips, which are secured to the external anodic walls of the shells delimiting each cell, the stiffness of the cathode current distributor and of the anodic structure and the elasticity of the conductive element cooperate to maintain a uniform cathode-to-separator contact with a homogeneous pressure distribution, while a suitable mechanical load of the contact strips is simultaneously ensured. By the use of the elastic element, damage to the electrodes is thus avoided.

EP 2734658 B1 (NEW NEL HYDROGEN) comprises a module for an electrolyzer of the filterpress type, which comprises at least one closed frame that defines at least one first opening, wherein the module comprises a sealing and electrically insulating material and this material at least partly covers the surface of the frame.

EP 2746429 A1 (UHDENORA) proposes an electrolysis cell, which contains an anode compartment with an anode and a cathode compartment with a gas diffusion cathode, the two electrodes being separated from each other by an ion exchange membrane, as well as a metallic elastic element which is clamped under compression between the back wall of the cathode gas compartment and the gas diffusion cathode, said elastic element being clamped into the cathode gas compartment such that the distance between the element and the back wall increases in the direction of gravity.

EP 2872675 B1 (UHDENORA) proposes an insulating frame for electrolysis cells, which has a geometric form with corners, the frame being of a flat design and having an anode and a cathode side as well as an outer and inner end face. The insulating frame has an edge region, which directly adjoins the inner end face and has recesses in the form of cut-outs in the region of the corners.

According to JP 2003 041388 A1 (ASFPONC), the stabilization of the cell is achieved by a metallic zigzag profile that is built into the cathode gas compartment. This embodiment of the electrolysis cell, however, entails a problem: physics dictates that the hydrostatic pressure in the anode compartment is not constant but increases in the direction of gravity. It would therefore be desirable, and entirely sufficient with a view to the object to be achieved, for the pressure exerted by the resilient inserts to be matched to the hydrostatic pressure, that is to say for it to increase in the direction of gravity.

### SUMMARY

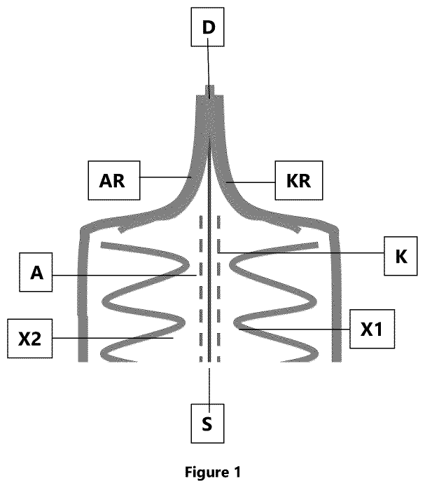

An electrolysis cell consists schematically of an anode compartment and a cathode compartment (AR, KR), which respectively contain the anode (A) and the cathode (K). The two electrodes are on the one hand separated from one another by a diaphragm, or a separator membrane (S), and on the other hand are respectively fixed with the aid of a resilient or stiff spacer (X1, X2) in the corresponding housing parts (“half-cells”), as may be seen schematically from FIG. 1. The figure furthermore illustrates the seal (D), which separates and externally seals the two electrode compartments at the perimeter.

The anode and cathode compartments need to be electrically insulated from one another so that a short circuit does not occur. For optimal performance, it is furthermore necessary for the electrodes to bear on the separator membrane in a planar fashion—i.e. without gaps—over their entire surface. This is achieved by one or more resilient spacers (X1, X2) inside the cell. In addition, the electrolysis cell is placed under slight positive pressure with respect to the atmosphere, which means that the seal must be both chemically stable and pressure resistant.

As explained above, for this purpose solutions that are very elaborate in terms of design have been proposed in the sealing region in the outward direction, but also between the half-shells that form the electrode compartments. For example, a seal as well as an insulating body are used at the perimeter in the individual elements. These are pressed by an external force, so that a force-fit occurs. Alternatively, the sealing and insulation are achieved by elastomers that are compressed under force. The force is applied by a filterpress-like structure and is distributed over both the seal and the inner inserts, if they comprise resilient spacers on the inside. Added to the technical outlay, there is then also the disadvantage that unequal forces act on the elastomer and the internal pressure of the cell reduces the force acting on the elastomer seals.

The object of the present invention was therefore to provide an alternative method for the sealing of electrolysis cells, which is associated with less technical outlay, avoids a short circuit and furthermore fully satisfies the following requirement profile:
reliable insulation and sealing of the anode and cathode, or anode and cathode compartments, by material bonding;
pressure resistance;
high mechanical stability;
high chemical stability; and
thermal cycle stability.

### DESCRIPTION OF THE INVENTION

In a first embodiment, the invention relates to a method for the sealing and electrical insulation of electrolysis cells, comprising or consisting of the following steps:
(a) providing an electrolysis cell containing or consisting of:
   (a1) two metallic half-cells, which form the anode and cathode compartments,
   (a2) an anode and a cathode respectively arranged therein,
   (a3) a separator membrane, which separates the two electrodes from one another, and
   (a4) optionally spacers, which position the two electrodes in their respective electrode compartments,
   (a5) wherein the two half-cells are separated from one another over their periphery by a gap, and
(b) introducing an electrically insulating plastic into the sealing surface between the two half-cells.

Surprisingly, it has been found that the requirement profile explained in the introduction can be fully satisfied in this way. The introduction of the plastic compound is substantially simpler and quicker than the measures hitherto known from the prior art, and in particular the external force application may be obviated. Specifically, a material bond is generated between the insulating plastic as a sealing compound and the metallic half-cells. Instead of a pure force-fit, a substantially more resistant connection is thus achieved. The seal proves to be pressure resistant, thermally and chemically stable and mechanically stable and ensures unimpaired electrical insulation even over long service lives or cycles of the cell. Furthermore, the alternative according to the invention is substantially more economical.

### Sealing of the Electrolysis Cell

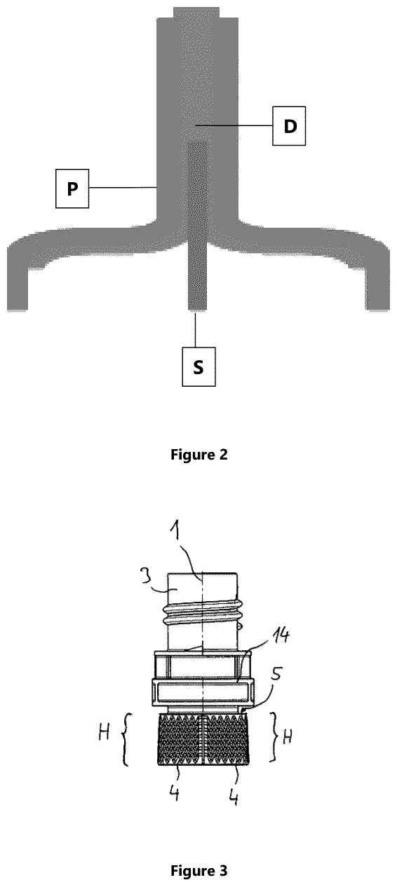

FIG. 2 schematically shows a cross section of the perimeter (P) over which the sealing compound (D) is distributed; the separator membrane (S), the ends of which are likewise enclosed by the sealing compound, may be seen in the middle. In this way, the membrane is simultaneously fastened and stabilized in the cell.

The half-cells preferably consist of stainless steel, nickel or titanium, and corresponding alloys, which may also contain further extraneous metals, for example vanadium.

The introduction of the plastic compound may be carried out according to the conventional methods of plastics processing, that is to say for example by thermal direct joining, bonding, hot-melt or lamination. Thermal joining is particularly preferred because of its technical simplicity. It works in a similar way to the injection-molding method: the plastic is liquefied and injected into the sealing surface. There, the polymer returns to the solid state by cooling and seals the two half-cells. Thermoplastics may essentially be envisioned as suitable electrically insulating plastics, perfluoroalkoxy polymers (PFA) and polyphenylene sulfides (PPS) being preferred because of their high chemical stability.

### Inlet and Outlet Connections

In another preferred embodiment of the present invention, inlet and outlet connections are introduced into the join between the two half-cells. In this case, in particular, connections that are known from the food industry may be envisioned, such as the welded spouts consisting of injection-moldable plastic as are illustrated in FIG. 3. Corresponding connections, or spouts, are the subject of EP 2644530 A1 (POPPELMANN), the teaching of which is included by reference, insofar as it relates to the nature of the spouts. The connections or spouts in this case have a neck (3) provided with a pouring channel (2) having a vertical longitudinal midaxis (1) as well as two outer side surfaces connected thereto, and preferably provided with welding lines (4) that are intended for welding to the seal of the electrolysis cell, and a multiplicity of stiffening webs are arranged on its associated side walls on the inside.

In general, said outlets or spouts have a so-called “boat” base, the side walls of which have outer side surfaces that merge into one another in their end regions. The side surfaces are connected, in particular welded, to and between the two film walls of a container. A collar-like region is typically formed integrally on the boat, or the side surfaces, and merges into a neck comprising an outlet channel that has a vertical longitudinal midaxis. Such a neck is often provided with a screw thread on the outside in order to secure a filled film bag with a cap before emptying through the outlet channel. Alternatively, the neck may also at least partially merge directly into the boat. The side surfaces of the boat may be planar, roughened, with or without ribs and/or provided with welding lines. Furthermore, the neck may comprise guide webs that can be used for guiding in a filling or sealing apparatus.

The attachment of the connections or spouts to the seal is carried out according to the teaching of EP 2644530 A1, generally by ultrasonic welding. In this invention, welded spouts are preferably introduced directly in the joining process.

### Electrolysis Cell

A further subject of the invention relates to an electrolysis cell that has been sealed by the method according to the invention. Specifically claimed is an electrolysis cell comprising or consisting of
(i) two metallic half-cells, which form the anode and cathode compartments,
(ii) an anode and a cathode respectively arranged therein,
(iii) a separator membrane, which separates the two electrodes from one another, and
(iv) optionally spacers, which position the two electrodes in their respective electrode compartments,
(v) wherein the two half-cells are separated from one another over their periphery by a gap, and
(vi) the sealing surface between the two half-cells is adhesively connected by an electrically insulating plastic by means of material bonding.

Preferably, the anode and cathode are arranged schematically in the cell as in FIG. 1, specifically so that the two electrodes are positioned with respect to one another in a planar fashion and without gaps over their entire surface, only the separator membrane connecting a direct contact. The spacers may be coils, rings, foams, mattresses or rigid structures, as referred to in the introduction in the citation of the prior art. They may be static or resilient, it being preferred to equip at least one electrode compartment with resilient spacers. In order to ensure that the electrodes are applied in a planar fashion. The individual electrolysis cells may be interconnected to form groups (“electrolyzers”) and used for example in chloralkali electrolysis, although the preferred application is the production of hydrogen by electrolysis of water.

### INDUSTRIAL APPLICATION

A further subject of the invention relates to the use of electrically insulating plastics, preferably thermoplastics and in particular perfluoroalkoxy polymers (PFA) and polyphenylene sulfides (PPS), for the sealing and electrical insulation of electrolysis cells, in which case the sealing may for example be carried out by thermal direct joining, bonding, hot-melt or lamination.

1. A method for the sealing and electrical insulation of electrolysis cells, comprising or consisting of the following steps:
(a) providing an electrolysis cell containing or consisting of:
(a1) two metallic half-cells, which form the anode and cathode compartments,
(a2) an anode and a cathode respectively arranged therein,
(a3) a separator membrane, which separates the two electrodes from one another, and
(a4) optionally spacers, which position the two electrodes in their respective electrode compartments,
(a5) wherein the two half-cells are separated from one another over their periphery by a gap, and
(b) introducing an electrically insulating plastic into the sealing surface between the two half-cells.

2. The method as claimed in claim 1, wherein the sealing is carried out adhesively by thermal direct joining, bonding, hot-melt or lamination.

3. The method as claimed in claim 1 wherein the half-cells are comprised of stainless steel, nickel or titanium, or corresponding alloys, which may also contain further extraneous metals, the extraneous metal optionally being-vanadium.

4. The method as claimed in claim 1, wherein the electrically insulating plastics are thermoplastics.

5. The method as claimed in claim 4, characterized in that thermoplastics selected from the group of perfluoroalkoxy polymers (PFA) and polyphenylene sulfides (PPS) are used.

6. The method as claimed in claim 1, wherein the seal also encloses the ends of the separator membrane and fixes the latter in the cell.

7. The method as claimed in claim 1, further comprising inlet and outlet connections that are introduced into the join between the two half-cells.

8. The method as claimed in claim 7, characterized in that welded spouts are used as inlet and outlet connections.

9. An electrolysis cell comprising or consisting of
(i) two metallic half-cells, which form the anode and cathode compartments,
(ii) an anode and a cathode respectively arranged therein,
(iii) a separator membrane, which separates the two electrodes from one another, and
(iv) optionally spacers, which position the two electrodes in their respective electrode compartments,
(v) wherein the two half-cells are separated from one another over their periphery by a gap, and
(vi) the sealing surface between the two half-cells is adhesively bonded by an electrically insulating plastic.

10. (canceled)
